(19) United States
(12) Patent Application Publication
(10) Pub. No.: US 2011/0012328 A1
(43) Pub. Date: Jan. 20, 2011

(54) SIDE CURTAIN AIRBAG WITH PRESSURE CONTROL DEVICE

(75) Inventors: Kurt Lewis Ewing, Plymouth, MI (US); Matthew B. Makowski, Northville, MI (US); Joseph Edward Abramczyk, Farmington Hills, MI (US); Brian Robert Spahn, Plymouth, MI (US); Mary A. Mason, Dearborn, MI (US); Anthony Edmond Rencher, Southfield, MI (US); Abdelmonaam Sassi, Windsor (CA); Selvakumar Inbaraj Daniel, Novi, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/504,765

(22) Filed: Jul. 17, 2009

(51) Int. Cl. B60R 21/16

(52) U.S. Cl. 280/730.2

(57) ABSTRACT

An inflatable safety curtain for use in a vehicle interior is provided. A first inflatable portion may be mounted to the vehicle interior. A second inflatable portion may be mounted to the first portion. The first and second portions may be in fluid communication. A pressure control device is disposed between the first and second inflatable portions to selectively prevent fluid communication between the first and second portion. The pressure control device is a flexible valve from fabric or a memory shape material, a chamber valve having an enlarged opening, or a flapper valve.

### BACKGROUND

1. Technical Field

Embodiments of the invention relate to side curtain airbags for use in passenger vehicles.

2. Background Art

A variety of vehicle test protocols are employed to measure vehicle safety in side impact. Two examples of such protocols are the Lateral New Car Assessment Program (LINCAP) and the Insurance Institute for Highway Safety (IIHS) side impact modes. Generally, such impact tests include an anthropomorphic test device (ATD) in the front and rear seating positions. Various ATD responses are measured and analyzed to assess the risk of occupant injury. Typically, these ATD responses are controlled by adjusting the vehicle structure and/or interior trim stiffness. Vehicle environmental limitations may make it difficult to adjust the underlying structure or trim to adequately control ATD responses during testing. Hence, other methods, such as inflatable side airbags have been employed to aid in managing ATD responses. One side airbag design includes a curtain airbag positioned between the occupant and the vehicle trim. The curtain airbag may be provided with a secondary airbag chamber.

### SUMMARY

According to one embodiment of the present invention, an inflatable vehicle safety curtain is provided. The inflatable curtain includes a first portion adapted to be mounted to an inflator. The inflatable curtain includes a second curtain mounted to the first portion. The first portion extends along a first vehicle interior region. The second portion extends along a second region. The inflatable curtain is provided with a flexible unidirectional valve. The flexible valve is positioned between the first portion and second portion to maintain a level of inflation of the second portion during occupant impact.

According to another embodiment, the first portion may be adapted to be mounted to a vehicle body. The first portion and second portion may be inflated by the inflator in response to an impact condition.

According to yet another embodiment, the flexible valve may permit fluid to pass from the first portion to the second portion. The flexible valve may limit fluid from passing from the second portion to the first portion.

According to yet another embodiment, the flexible valve may be formed of a fabric.

According to still another embodiment, the flexible valve may be formed of a memory shape material.

According to another embodiment, the inflatable safety curtain may include a diffuser tube. The diffuser tube may extend from the inflator to facilitate inflation of first portion or the second portion in response to an impact condition.

According to another embodiment, the flexible valve may be positioned within the diffuser tube.

According to yet another embodiment, the first region may be adjacent to the second region. Inflation of the second portion may cause the second portion to be positioned adjacent to a rib cage of an occupant. The second portion may be adapted for impact with the rib cage of the occupant.

According to another embodiment, the second portion may be integrally formed with the first portion.

According to another embodiment, the second portion may be in fluid communication with the inflator via the first portion.

According to another embodiment, an inflatable safety curtain is provided with a first inflatable portion. The first inflatable portion is adapted to be mounted to a vehicle body. The first inflatable portion is in fluid communication with an inflator to inflate the first inflatable portion in response to an impact condition. Inflation causes the first portion to extend along an interior side of the vehicle body. The first portion extends at a first region. The inflatable safety curtain is provided with a second inflatable portion for fluid communication. The second portion is in fluid communication with the inflator for inflation of the second portion in response to an impact condition. Inflation causes the second portion to extend along an interior side of the vehicle body at a second region. The inflatable safety curtain is provided with a chamber valve assembly oriented between the first portion and the second portion. The chamber valve assembly includes a housing having a first opening toward the first inflatable portion. The chamber valve also includes a second opening toward the second portion, opposed from the second opening. The second opening is greater than the first opening. The chamber valve is provided with a valve member within the chamber. The valve member is actuated toward the second opening by fluid flow from the first portion to the second portion. Fluid is permitted to pass from the first portion to the second portion. The valve member is actuated toward the first opening by fluid flow from the second portion to the first portion. Fluid is limited from passing from the second portion to the first portion to maintain a level of inflation during impact with an occupant.

According to another embodiment, the valve member may be a cylinder.

According to yet another embodiment, the valve member may be a ball.

According to still another embodiment, the inflatable safety curtain may be provided with a spring. The spring may urge the valve member toward the second opening.

According to another embodiment, an inflatable safety curtain is provided with a first inflatable portion. The first inflatable portion is adapted to be mounted to a vehicle body. The first inflatable portion is in fluid communication with an inflator to inflate the first inflatable portion in response to an impact condition. Inflation causes the first portion to extend along an interior side of the vehicle body. The first portion extends at a first region. The inflatable safety curtain is provided with a second inflatable portion for fluid communication. The second portion is in fluid communication with the inflator for inflation of the second portion in response to an impact condition. Inflation causes the second portion to extend along an interior side of the vehicle body at a second region. The inflatable safety curtain is provided with a flapper valve oriented between the first portion and the second portion. Fluid is permitted to pass from the first portion to the second portion. Fluid is limited from passing from the second portion to the first portion to maintain a level of inflation during impact with an occupant.

According to yet another embodiment, the flapper valve may be pivotally connected to the first portion or the second portion.

According to still another embodiment, the flapper valve may be formed from a plastic.

According to another embodiment, the flapper valve may be formed from a fabric.

According to still another embodiment, the flapper valve may include an actuating member. The flapper valve may also include an elongate member adapted to be received within the actuating valve member. The actuating valve member may receive the elongate member when the flapper valve limits fluid from passing from the second portion to the first portion.

According to another embodiment, the flapper valve may have a first surface area exposed to the interior of the first inflatable portion. The flapper valve may have a second surface area exposed to the interior of the second inflatable portion. The second surface area may be greater than the first surface area.

### BRIEF DESCRIPTION OF THE DRAWINGS

FIG. 1 is a partial perspective view of a vehicle interior with an inflatable curtain assembly illustrating the inflatable curtain assembly in a deployed position according to an embodiment of the present invention;

FIG. 2 is a section view of the inflatable curtain assembly of FIG. 1 according to an embodiment of the present invention;

FIG. 3 is a section view of the inflatable curtain assembly of FIG. 1 according to another embodiment of the present invention illustrating;

FIG. 4 is a section view of the inflatable curtain assembly of FIG. 1 according to another embodiment of the invention;

FIG. 5 is an enlarged partial section view of a pressure control device for the inflatable curtain assemblies of FIGS. 2-4 according to an embodiment;

FIG. 6 is a top plan view of another pressure control device for the inflatable curtain assemblies of FIGS. 2-4 illustrated in a closed position according to another embodiment;

FIG. 7 is another top plan view of the pressure control device of FIG. 6 illustrated in an open position according to another embodiment;

FIG. 8 is a perspective view of another pressure control device for the inflatable curtain assemblies of FIGS. 2-4 according to yet another embodiment; and

FIG. 9 is a side elevation view of another pressure control device for the inflatable curtain assemblies of FIG. 2-4 according to another embodiment.

### DETAILED DESCRIPTION

As required, detailed embodiments of the present invention are disclosed herein; however, it is to be understood that the disclosed embodiments are merely of the invention that may be embodied in various and alternative forms. The figures are not necessarily to scale; some features may be exaggerated or minimized to show details of the particular components. Therefore, specific structural and functional details disclosed herein are not to be interpreted as limiting, but merely as a representative basis for the claims and/or as a representative basis for teaching one skilled in the art to variously employ the present invention.

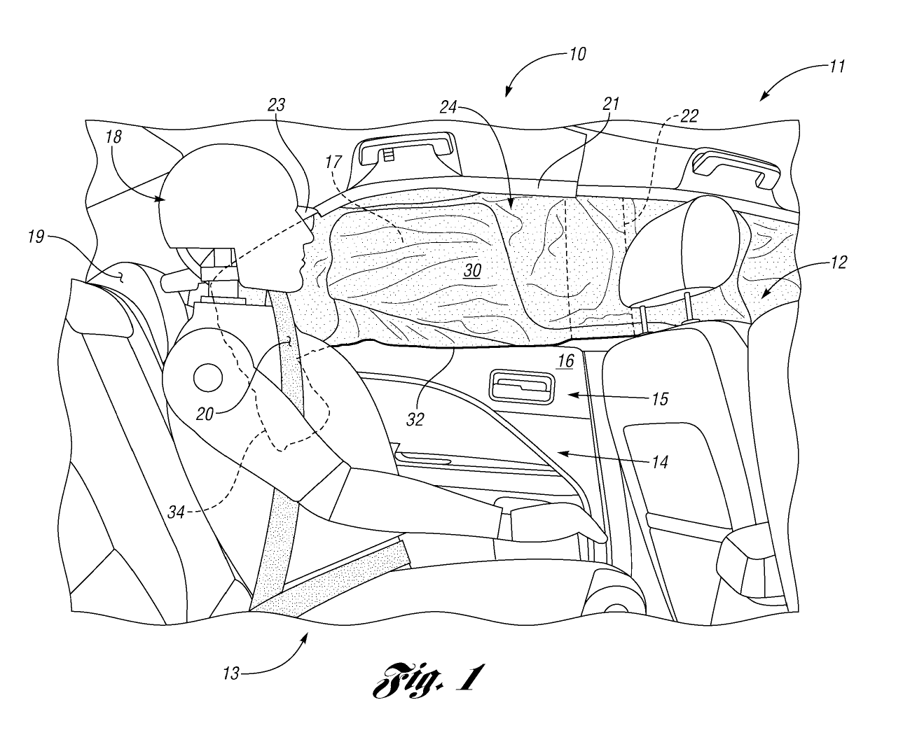

With reference to FIG. 1, a vehicle interior is partially illustrated and referenced generally by the numeral 10. The vehicle interior 10 is the interior of a vehicle body 11. The vehicle interior 10 includes a first seating row 12. The first seating row 12 is illustrated as containing individual bucket seats, however any style vehicle seat may be employed. The vehicle interior 10 also includes a second seating row 13. Although bench seats are illustrated in the second seating row 13, any style vehicle seat may be employed. The illustrated embodiment depicts a driver's side 14 of the vehicle interior 10 for the United States. However, the invention contemplates use with any side of a vehicle interior 10. The vehicle interior 10 is illustrated with two seating rows, however providing additional seating rows is contemplated within the scope of the invention.

In the illustrated embodiment, the vehicle body 11 provides a door 15. The door 15 depicted in the illustrated embodiment corresponds to the second seating row 13. The door 15 includes a door trim panel 16. The door 15 also includes a window 17 corresponding with the second seating row 13. The window 17 for the illustrated embodiment is retractable within in the door 15. Various arrangements of doors and windows may be provided within the scope of the invention. Additional doors and windows may be provided to correspond with additional seating rows.

The seating rows 12, 13 are sized to seat occupants, such as an occupant 18 depicted in FIG. 1. The second seating row 13 may be provided with head restraints 19 for vehicle occupant safety. The illustrated second row 13 also includes vehicle safety harnesses 20.

The vehicle body 11 includes a roof 21. The vehicle body 11 is provided with vertical supports to support the roof 21. For the second seating row 13, the vehicle body 11 is illustrated with a B-pillar 22 and a C-pillar 23.

The vehicle body 11 is provided with an inflatable safety curtain assembly 24. The inflatable safety curtain assembly 24 includes an inflatable safety curtain 30. The inflatable safety curtain 30 includes a first inflatable portion 32. The inflatable safety curtain 30 also includes a second inflatable portion 34. The inflatable safety curtain assembly 24 includes an inflator 38. The inflator 38 causes the inflatable safety curtain 30 to inflate.

The vehicle occupant 18 is illustrated seated in second seating row 13, adjacent the inflatable safety curtain 30. During a vehicle impact, the occupant 22 may shift and collide with the vehicle body 11 at the door 15 or the window 17. The inflator 38 causes the inflatable safety curtain to inflate, thereby expanding over the door 15 and the window 17 for separating the occupant 18 from the door 15 and the window 17.

The first inflatable portion 32 inflates to prevent the occupant 18 from striking the door 15 and the window 17, or to dampen the impact. The second inflatable portion 34 also prevents the occupant 18 from striking the vehicle door 15, or dampens the impact. The occupant 18 is illustrated in a seated position with a torso positioned proximate the vehicle door 15. The second inflatable portion 34 inflates to further prevent the occupant's torso from striking the door 15. The first and second portions 32, 34 are illustrated inflated between the occupant 18 and the window 17 and a rearward region of the door 15; however any arrangement of the first and second portion 32, 34 is contemplated within the scope of the invention. Although the second inflatable portion is depicted in the second seating row 13, the invention contemplates that the second inflatable portion 34 may be employed within any seating row of the vehicle 11, such as the first seating row 12, or any subsequent seating row. Further, the invention contemplates that the second inflatable portion 34 may be employed in multiple seating rows, such as the first and second seating rows 12, 13.

In one embodiment, the first inflatable portion 32 has a size that is different than a size of the second inflatable portion 34. In the illustrated embodiment, the first inflatable portion 32 is larger than the size of the second inflatable portion 34 when inflated.

With reference to FIG. 2, the inflatable safety curtain assembly 24 is illustrated according to an embodiment. The inflatable curtain 30 includes the first inflatable portion 32 and the second inflatable portion 34. The first portion 32 and second portion 34 are illustrated as a single integrally formed curtain 30 separated into two portions. In an alternate embodiment, the first portion 32 and the second portion 32 may be formed separately and attached.

According to the illustrated embodiment, the second inflatable portion 34 is positioned adjacent the first inflatable portion 32. The second inflatable portion 34 is shown extending at one end of the first portion 32 and below the first portion 32; however alternate configurations of the first and second portion 32, 34 are contemplated within the scope of the present invention. In the embodiment illustrated, the first inflatable portion 32 includes multiple chambers 39. As the first inflatable portion 32 is inflated, the chambers 39 allow the first inflatable portion 32 to expand uniformly. In other embodiments, the first and second portions 32, 34 may be formed of multiple curtain chambers joined together. In another alternate embodiment, the first and second portions 32, 34 may each be formed from a single inflatable chamber. Any suitable chamber design may be used without departing from the present invention.

The first inflatable portion 32 is in fluid communication with the second inflatable portion 34. The inflatable safety curtain assembly 24 includes the inflator 38. The inflator 38 is in fluid communication with the first inflatable portion 32. In the embodiment illustrated, the inflatable safety curtain assembly 24 includes a diffuser tube 42. The diffuser tube 42 is connected to the first inflatable portion 32 and the inflator 38. The first inflatable portion 32 may be inflated by the inflator through the diffuser tube 42.

In the illustrated embodiment, the inflator 38 causes inflation of the first inflatable portion 32 in response to an impact condition. Inflation of the first inflatable portion 32 causes the first portion to extend along the interior 10 of the vehicle body 11. The first portion 32 extends along the side region 14 of the interior 10. In the illustrated embodiment, the first portion 32 is mounted to the roof 21 of the vehicle body 11.

In the embodiment shown, the second inflatable portion 34 is also in fluid communication with the inflator 38. The diffuser tube 42 connects the inflator 38 with the second inflatable portion 34. The diffuser tube 42 acts as a fill tube between the inflator 38 and the second portion 34. The second inflatable portion 34 is also inflated by the inflator 38. The second inflatable portion 34 may be sealed from the first portion 32 by a pair of seals 40, 41. The seals 40, 41 may each be provided by, for example, a sew line. Alternately, the seals 40, 41 may include tethers, such as zero-length tethers. The seals 40, 41 prevent gas flow from the second inflatable portion 34 to the first inflatable portion 32, thereby isolating the second inflatable portion 34.

The inflator 38 causes inflation of the second inflatable portion 34 in response to an impact condition. In the illustrated embodiment, inflation of the second inflatable portion 34 causes the second portion 34 to extend along the interior 10 of the vehicle body 11. The second portion 34 may extend along the side 14 of the interior 10. The second inflatable portion 34 is adjacent the first inflatable portion 32 when inflated.

The diffuser tube 42 has one or more outlets 46 for allowing gas from the inflator 38 out of the diffuser tube 42 into the chambers of the inflatable safety curtain 30. According to the illustrated embodiment, the diffuser tube 42 facilitates gas flow from the inflator 38 to the first inflatable portion 32. The first inflatable portion 32 is illustrated as being in fluid communication with several diffuser tube outlets 46. The second portion 34 is also in fluid communication with the inflator 38. The second inflatable portion 34 is illustrated as being in fluid communication with one diffuser tube outlet 46. It is contemplated by the invention that the number of outlets 46 in fluid communication with the first portion 32 and second portion 34 may be varied from the depicted embodiment.

In the embodiment illustrated, a pressure control device 50 may be positioned within the diffuser tube 42 at the outlet 46 the second inflatable portion 34. When the second inflatable portion 34 is inflated, the pressure control device 50 prevents gas flow from the second inflatable portion 34 to the diffuser tube 42. Although the pressure control device 50 is depicted in a particular location in FIG. 2, the invention contemplates various embodiments with various locations of pressure control devices 50. Alternatively, the invention contemplates an embodiment that achieves desired results without employing a valve.

Moreover, the pressure control device 50 is positioned between the first inflatable portion 32 and the second inflatable portion 34. The pressure control device 50 is a unidirectional flexible valve for at least one embodiment. The pressure control device 50 allows gas flow into the second inflatable portion 34 and limits gas flow out of the second inflatable portion 34. In the illustrated embodiment, the pressure control device 50 may be positioned for example within the diffuser tube 42. The pressure control device 50 may be positioned within the diffuser tube outlet 46 such that gas provided by the inflator 38 to the diffuser tube 42 enters the second inflatable portion 34. The pressure control device 50 can limit gas within the second inflatable portion 34 from passing into the diffuser tube 42 or the first inflatable portion 32. The gas from the inflator 38 enters the second inflatable portion 34 and is unable to escape.

The pressure control device 50 may be a flexible valve. Thus, when the second inflatable portion 34 is inflated, the flexible valve 50 is in a closed position. The flexible valve 50 may be formed from fabric or a memory shape material. In one embodiment, the flexible valve 50 may also be a chamber valve. In an alternate embodiment, the flexible valve 50 is a flapper valve. In another alternate embodiment, the flexible valve 50 is a blow-out valve.

The inflator 38 is illustrated configured to provide inflation gas to the second inflatable portion 34 to cause the second inflatable portion 34 to inflate to a threshold level of inflation. The inflator 38 may stop providing inflation gas to the second portion 34 upon achieving the threshold level of inflation. In an alternate embodiment, the pressure control device 50 may be configured to prevent inflation gas from passing into the second inflatable portion 34 upon achieving the threshold level of inflation. In another alternate embodiment, the pressure control device 50 may permit gas flow from the second inflatable portion 34 to the first inflatable portion 32 until a level of pressure equilibrium is achieved between the first inflatable portion 32 and the second inflatable portion 34.

As illustrated, the second inflatable portion 34 is aligned with the second seating row 13. However, the present disclosure is contemplated for use with any seating row. The second inflatable portion 34 could be aligned, for example, with the first seating row 12. In a vehicle including a third seating row or additional rows, the second inflatable portion 34 could be aligned with the third row without departing from the spirit and scope of the invention.

In response to an impact condition, the first and second inflatable portions 32, 34 inflate. The vehicle occupant 18 may impact the inflatable safety curtain 30 during the impact position. The second inflatable portion 34 is positioned to be impacted by the torso of the vehicle occupant 22. The impact partially compresses the second inflatable portion 34, increasing pressure inside the second inflatable portion 34. During the impact, the pressure control device 50 is in a closed position to prevent fluid flow out of the second inflatable portion 34. Thus, the second inflatable portion 34 maintains a level of inflation of the second portion 34 during impact with the occupant 18.

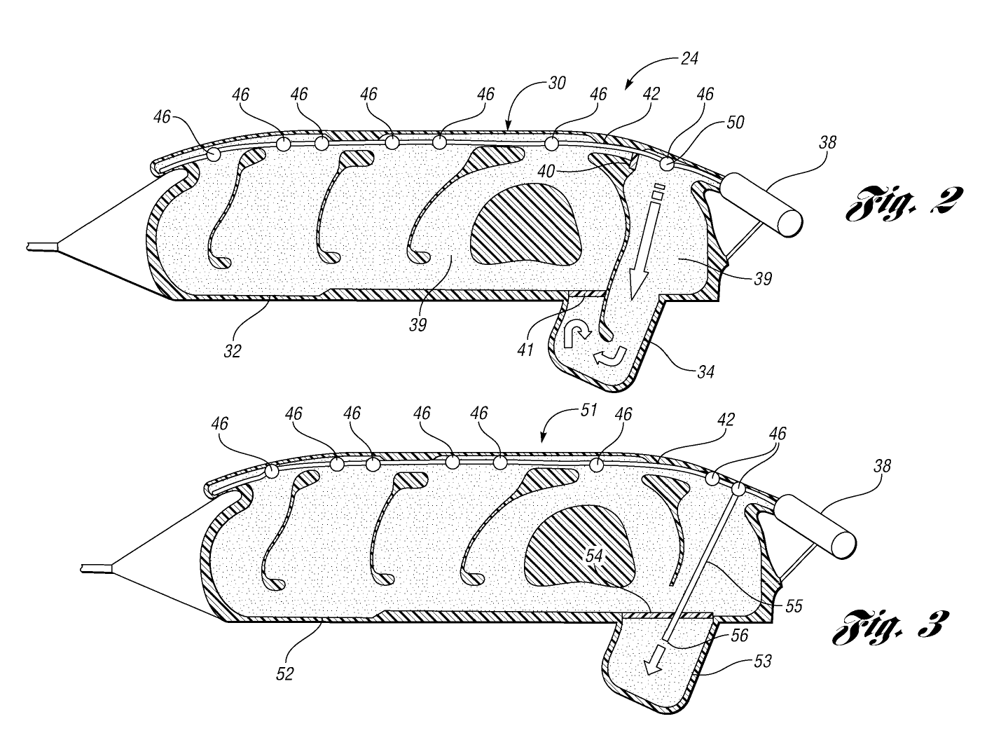

With reference to FIG. 3, an alternate embodiment inflatable safety curtain assembly 51 is illustrated. The inflatable safety curtain assembly 51 is similar to the assembly 24 of FIG. 2, with like reference numerals identifying like structure. The inflatable safety curtain assembly 51 includes a first inflatable portion 52 and a second inflatable portion 53 extending entirely beneath the first portion 52. A seal 54 isolates the second portion 53 from the first portion 52.

The inflatable safety curtain assembly 51 includes a diffuser tube 42 as a fluid conduit. The diffuser tube 42 permits fluid communication between the inflator 38 and the first inflatable portion 52. The diffuser tube 42 includes a diffuser tube extension 55. The diffuser tube extension 55 acts as a fill tube between the diffuser tube 42 and the second inflatable portion 53. The diffuser tube extension 55 permits fluid communication between the inflator 38 and the second inflatable portion 53. The diffuser tube extension 55 acts as a dedicated fill tube for the second inflatable portion 53.

A pressure control device 56 may be disposed within the diffuser tube extension 55 for preventing deflation of the second inflatable portion 53 during impact. In one embodiment, the pressure control device 56 is positioned within the second inflatable portion 53 at an end of the diffuser tube extension 55. The arrangement of the inflator 38, diffuser tube 42, and diffuser tube extension 55 may be varied without departing from the scope and spirit of the disclosure.

The second inflatable portion 53 can be spaced apart from the diffuser tube 42 and inflator 38. The fill tube 55 extends through the first inflatable portion 52 to connect with the second inflatable portion 53 and the inflator 38. The fill tube 55 facilitates fluid communication between the inflator 38 and the second inflatable portion 53. In one embodiment, the fill tube 55 may be formed from a flexible material. Thus the fill tube 55 may be stored within the first inflatable portion 52 prior to inflation. In one embodiment, the fill tube 55 is formed integrally with the first inflatable portion 52. The fill tube 55 may be formed of, for example, a fabric. Prior to inflation, the fill tube 55 and the first inflatable portion 52 may be rolled or folded together in a stored position.

The second inflatable portion 53 is illustrated in the embodiment as being positioned below the first inflatable portion 52. For the purpose of this description, the terms below and lower generally refer to positions having a lesser elevation during typical vehicle operation.

The inflator 38 may inflate the second inflatable portion 53 through the fill tube 55. The inflator 38 may also inflate the first inflatable portion 52 through the diffuser tube 42. The level of inflation of the second inflatable portion 53 may be independent of the level of inflation of the first inflatable portion 52. Accordingly, during inflation, the pressure inside the second inflatable portion 53 may be different than the pressure inside the first inflatable portion 52.

The pressure control device 56 may be disposed inside the diffuser tube 42. For example, the pressure control device 56 may be positioned at an interface of the diffuser tube 42 and the fill tube 55. In another embodiment, the pressure control device 56 may be positioned within the fill tube 55. The pressure control device 56 reduces or prevents gas flow from the second inflatable portion 34 following inflation.

Referring to FIG. 4, an inflatable curtain assembly 57 is illustrated with an alternate configuration. The inflatable curtain assembly 57 includes a first inflatable portion 58 and a second inflatable portion 59. The first inflatable portion 58 is illustrated as extending along the vehicle body 11. In the embodiment, the second inflatable portion 59 is disposed below the first inflatable portion 58. The inflatable curtain assembly 24 includes a diffuser tube 42 connected to the inflator 38. The diffuser tube 42 facilitates inflation of the first inflatable portion 58 by the inflator 38. The second inflatable portion 59 is isolated from the first inflatable portion 58 by a seal 60. The second inflatable portion 59 is in fluid communication with the first inflatable portion 58. The second inflatable portion 59 is configured to be inflated by the inflator 38 through the first inflatable portion 58.

A pressure control device 61 is illustrated at an interface between the first inflatable portion 58 and the second inflatable portion 59. The pressure control device 61 may be a flexible unidirectional valve as illustrated.

The pressure control device 61 has an open position and a closed position. The pressure control device 61 is oriented between the first and second portions 58, 59 to facilitate fluid flow from the first portion 58 to the second portion 59. The open position corresponds with the pressure control device 61 allowing fluid flow to the second portion 59. The closed position corresponds with the pressure control device 61 limiting fluid flow from the second portion 59 to the first portion 58. The pressure control device 61 is in the closed position during occupant impact with the inflatable safety curtain 30. In the closed position, the pressure control device 61 helps maintain the level of inflation of the second inflatable portion 59.

The flexible valve 61 illustrated in FIG. 4 is shown as a flapper valve. The flapper valve 61 is sized to prevent fluid communication between the first inflatable portion 58 and the second inflatable portion 59 during impact. In one embodiment, the flapper valve 61 is positioned inside the second inflatable portion 59. The flapper valve 61 is pivotally connected to the seal 60. The flapper valve 61 may be configured to be in a closed position prior to inflation. During inflation, pressure from the inflation gas delivered by the inflator 38 forces the flapper valve 61 to pivot into the second inflatable portion 59. The flapper valve 61 is also configured to return to the closed position when the pressure differential between the first inflatable portion 58 and the second inflatable portion 59 is reduced below a threshold value. In the closed position, the flapper valve 61 prevents fluid communication from the second inflatable portion 59 to the first inflatable portion 58.

The flapper valve 61 may be configured to permit inflation of the second inflatable portion 59 until the pressure inside the second inflatable portion 59 exceeds a threshold pressure value. In an alternate embodiment, the second inflatable portion 59 may be inflated until the pressure inside the first inflatable portion 58 exceeds a threshold pressure value. In another embodiment, the flapper valve 61 is configured to permit inflation of the second inflatable portion 59 until a desired pressure equilibrium between the first and second portions 58, 59 is achieved.

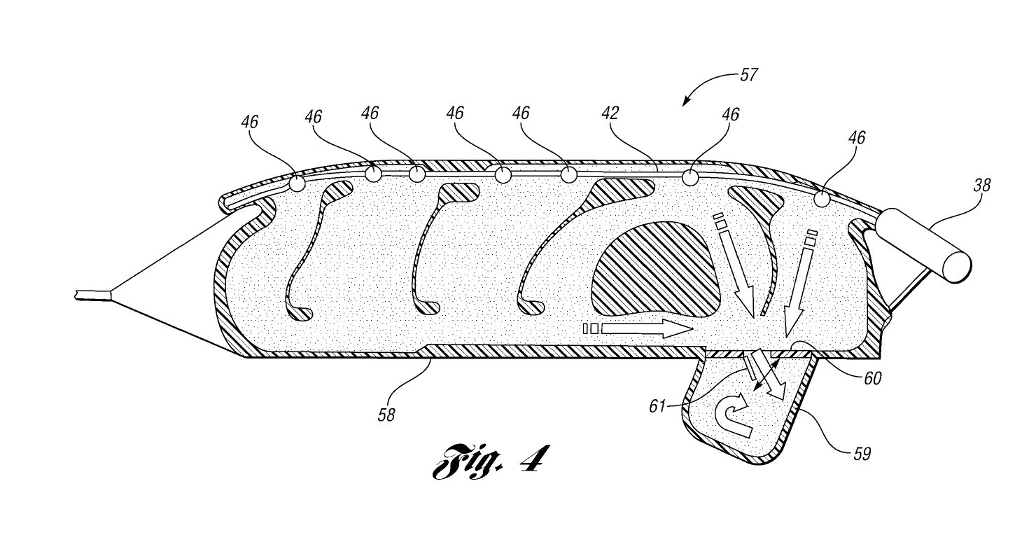

With reference to FIG. 5, a valve 62 is illustrated, which can be utilized as the pressure control device 50, 56, 61 of any of the previous embodiments. The valve 62 is a chamber valve positioned between the first inflatable portion 32 and the second inflatable portion 34. The chamber valve 62 includes a housing 63 to be positioned between the first and the second inflatable portions 32, 34. The housing 63 includes an internal chamber 64. The housing includes 63 two openings 65, 66. The first opening 65 is positioned between the chamber 64 and the first inflatable portion 32. The enlarged second opening 66 is positioned between the second inflatable portion 34 and the chamber 54. The enlarged second opening 66 is sized to be larger than the first opening 65.

The chamber valve 62 includes an actuator 67. The actuator 67 is sized to prevent fluid flow through the chamber valve 62. The actuator 67 is illustrated as a ball. The ball 67 is positioned within the chamber 64. The ball 67 moves between an open position illustrated in solid and a closed position illustrated in phantom. When the ball 67 is in the open position, the ball 67 is prevented from exiting the chamber 64, but fluid flows from the first inflatable portion 32 through the chamber 64 to the second inflatable portion 34 around the ball 67. When the ball 67 is moved to the closed position, the ball 67 is positioned at the first opening 65. The ball 67 is sized to block fluid flow from the second inflatable portion 34 through the chamber 64 and into the first inflatable portion 32 at the opening 65.

In the illustrated embodiment, the chamber 64 is of a generally conical shape. The first opening 65 is formed toward a tapered end of the conical shape. The enlarged opening 66 is positioned at the base of the conical shape. The ball 67 has a diameter greater than the diameter of the first opening 65. The ball 67 seals the opening 65 at the closed position. The illustrated embodiment includes a rest 68 toward the enlarged opening 66 of the chamber valve 62. The rest 68 prevents the ball 67 from escaping the chamber 64 through the enlarged opening 66. In the open position, the ball 67 sits on the rest 68 and gas flows around the ball 67 and the rest 68, through the chamber 64 and into the second inflatable portion 34.

When the second inflatable portion 34 is impacted by the vehicle occupant 22, gas begins to flow from the second inflatable portion 34 through the chamber 64. The ball 67 is forced by the gas flow toward the first opening 65. The ball 67 is held in the closed position during the impact of the second portion 34 by the pressure of the second portion 34. Inflation of the second portion 34 is maintained during impact by the occupant 18 because the ball 67 does not return to the open position while the second portion 34 is being compressed.

In one embodiment, the chamber valve 62 includes a spring (not shown). The spring is positioned to urge the ball 67 toward the first opening 65. When the inflator 38 causes gas to flow to the second inflatable portion 34 through the chamber valve 62, fluid pressure within the first inflatable portion 32 exceeds fluid pressure within the second inflatable portion 34. The increased pressure forces the ball 67 toward the enlarged opening 66, compressing the spring. As the second inflatable portion 34 inflates, the second portion pressure and the first portion pressure approach each other. When the first portion pressure and the second portion pressure approach equilibrium, fluid pressure from the first portion 32 provides insufficient force to compress the spring and urge the ball 67 toward the enlarged opening 66. The spring force and fluid pressure from the second portion urge the ball 67 toward the first opening 65, closing the chamber valve 62.

Though the embodiment of the chamber valve 62 is illustrated with a ball as an actuator 67, other actuators 67 are contemplated for use with the present invention. The actuator 67 may be, for example, a cylindrical piston or a flapper.

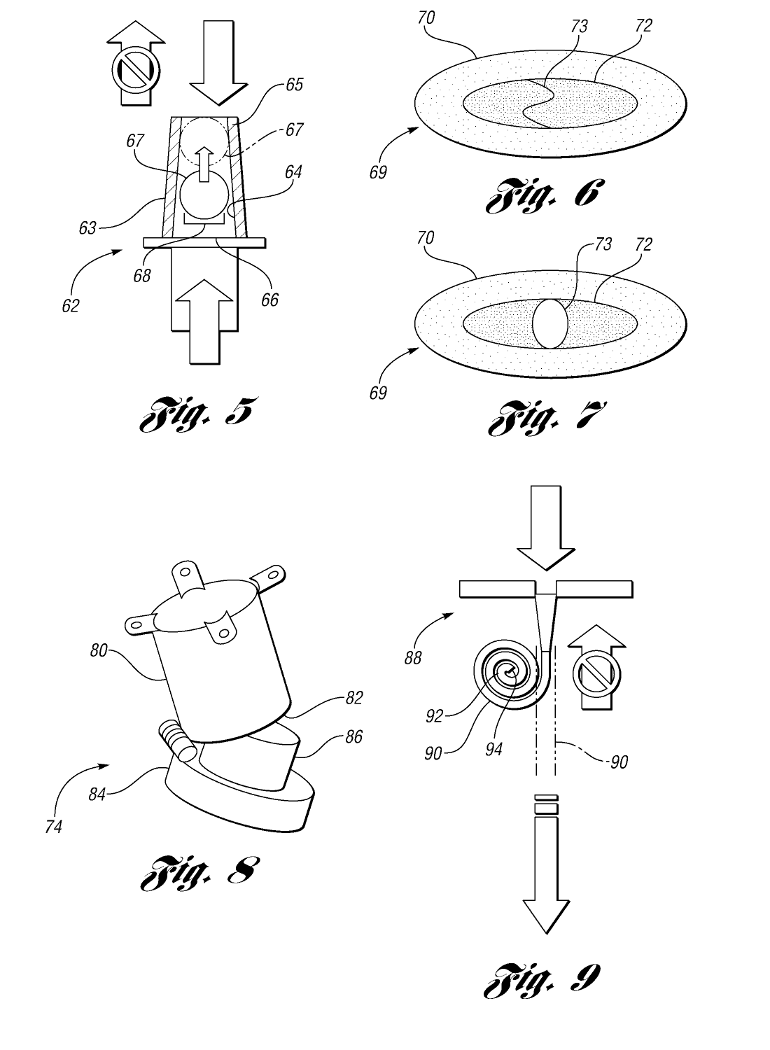

With reference to FIGS. 6 and 7, a flexible valve 69 is illustrated as a diaphragm valve. The diaphragm valve 69 is configured to be positioned between the first portion 32 and the second portion 34 to facilitate fluid flow from the first portion 32 to the second portion 34. The diaphragm valve 69 is contemplated for use with the inflatable curtain assemblies 24, 51, 57 of FIGS. 2-4. The size of the diaphragm valve 69 may be dependent on the size of the interface between the first inflatable portion 32 and the second inflatable portion 34.

The diaphragm valve 69 includes a valve housing 70. The diaphragm valve 69 also includes a flexible diaphragm 72 with an opening 73. Absent a pressure applied to the diaphragm 72, the opening 73 remains closed. In one embodiment, the diaphragm valve 69 is in a closed position prior to inflation. The closed position of the diaphragm valve 50 is illustrated by FIG. 6. During inflation, gas pressure from the inflator 38 forces the diaphragm 72 to an open position. The open position of the diaphragm 72 is illustrated by FIG. 7. The open position corresponds to the flexible valve 69 permitting fluid communication between the first inflatable portion 32 and the second inflatable portion 34. In one embodiment, the flexible diaphragm 72 is formed of a fabric. In another embodiment, the flexible diaphragm 72 is formed of a memory shape material.

Referring now to FIG. 7, the diaphragm valve 69 of FIG. 6 is forced to the open position by the inflator 38 to inflate the first and second portions 32, 34. When the pressure difference between the first portion 32 and the second portion 34 falls below a predetermined threshold, the flexible diaphragm 72 returns to the closed position. In one embodiment, the flexible valve 69 closes when the pressure within the second portion 34 exceeds a threshold pressure. Thus gas is prevented from escaping the inflated second inflatable portion 34. For example, the housing 70 may be positioned to permit the diaphragm 72 to extend towards the second curtain portion 34, but may also be positioned to prevent the diaphragm 72 from extending towards the first curtain portion 32. The diaphragm valve 69 limits fluid flow from the second inflatable portion 34 to the first inflatable portion 32 when the flexible diaphragm 72 is in the closed position.

FIG. 8 illustrates another variant of a flapper valve 74 for utilization as a pressure control device 50, 56, 61 for utilization with one of the embodiments of FIGS. 2-4. The flapper valve 74 is positioned between the first inflatable portion 32 and the second inflatable portion 34. The flapper valve 74 is oriented to allow fluid flow from the first inflatable portion 32 to the second inflatable portion 34. The flapper valve 74 may include a valve base 80. The valve base 80 may define an aperture 82. The aperture 82 may allow inflation by the inflator 38. The valve base 80 may be an elongated tube. As illustrated, the aperture 82 is disposed through the tube 80. The flapper valve 50 includes an actuating flapper 84. The flapper 84 covers the aperture 82 to prevent fluid communication through the valve aperture 82.

In the embodiment illustrated, the flapper 84 is pivotally connected to the valve base 80. The flapper valve 74 may be configured such that the flapper 84 covers the valve aperture 82 when the pressure within the second inflatable portion 34 exceeds a threshold pressure level. As illustrated, when the flapper 84 covers the valve aperture 82, a plug 86 on the flapper is received in the aperture 82 of the valve base 80. The flapper 84 may be biased to the closed position by a spring, such that the inflator must overcome the spring to force air into the second curtain portion 34. The spring may return the flapper 84 to the closed orientation thereby prevent air to escape the second curtain portion 34 during the impact by the occupant 18.

With reference to FIG. 9, a flexible valve 88 is illustrated as a blow-out valve. In the illustrated embodiment, the blow-out valve 88 is positioned at an interface between the first inflatable portion 32 and the second inflatable portion 34. The blow-out valve 88 is contemplated for use with the inflatable safety curtain assemblies 24, 51, 57 of FIGS. 2-4. The blow-out valve 88 operates in a manner similar to a party horn. In the open state, fluid flow into the second portion 34 is permitted. In the closed state, a free end of the blow-out valve folds or collapses so that fluid cannot flow from the second portion 34 to the first portion 32.

The blow-out valve 88 includes a flexible tube 90. The flexible tube 90 may be unfurled when the pressure differential between the first inflatable portion 32 and the second inflatable portion 34 exceeds a threshold value. The blow-out valve 88 can be configured such that during inflation by the inflator 38, the flexible tube 90 will unfurl. The flexible tube 90 may unfurl into the second inflatable portion 34. The second inflatable portion 34 may then be inflated through the blow-out valve 88. After the pressure differential between the first inflatable portion 32 and the second inflatable portion 34 is reduced below a threshold value, the flexible tube 90 curls or rolls to the closed position. In the closed position, gas flow from the second inflatable portion 34 is prevented.

As the fluid from the inflator 38 flows through the blow-out valve 99, the flexible tube 90 unfurls. A free end 92 of the flexible tube 90 may include a folded tip 94. The folded tip 94 allows gas from the inflator 38 to flow through the flexible tube 90 into the second portion 34 when the flexible tube 90 is straightened. The folded tip 94 flexes outward to open, allowing the fluid to escape the blow-out valve 88. When the pressure difference between the first portion 32 and the second portion 34 falls below a predetermined threshold, the folded tip 94 ceases to flex outward. The flexible tube 90 returns to the rolled state. When the second inflatable portion 34 is compressed, gas contained in the second inflatable portion 34 is prevented from entering the blow-out valve 50 by the folded tip 94.

In one embodiment, the blow-out valve 88 may be formed from a fabric. In another embodiment, the blow-out valve 88 is formed from a plastic. In yet another embodiment, the blow-out valve 88 is formed from a shape memory material. The blow-out valve 88 returns to the closed position when not being forced open.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed:

1. An inflatable vehicle safety curtain comprising:
a first inflatable portion adapted to be mounted to a vehicle body inflator to extend along a first vehicle interior region;
a second inflatable portion mounted for fluid communication to the first portion to extend along a second region; and
a flexible unidirectional valve disposed between the first and second portions to maintain a level of inflation of the second portion during occupant impact.

2. The inflatable vehicle safety curtain of claim 1 wherein the first portion is adapted to be mounted to a vehicle body and the first and second inflatable portions are configured for inflation by the inflator in response to an impact condition.

3. The inflatable vehicle safety curtain of claim 1, wherein the flexible valve is configured to permit fluid to pass from the first portion to the second portion and to limit fluid from passing from the second portion to the first portion.

4. The inflatable vehicle safety curtain of claim 1 wherein the flexible valve is formed of a fabric.

5. The inflatable vehicle safety curtain of claim 1 wherein the flexible valve is formed of a memory shape material.

6. The inflatable vehicle safety curtain of claim 1, further comprising a diffuser tube configured to extend from the inflator to facilitate inflation of one of the first portion and the second portion in response to an impact condition.

7. The inflatable vehicle safety curtain of claim 6, wherein the flexible valve is disposed within the diffuser tube.

8. The inflatable vehicle safety curtain of claim 1, wherein the first region is adjacent to the second region and inflation of the second portion causes the second portion to be disposed adjacent to a rib cage of the occupant and the second portion is adapted for impact with the rib cage of the occupant.

9. The inflatable vehicle safety curtain of claim 1, wherein the second portion is integrally formed with the first portion.

10. The inflatable vehicle safety curtain of claim 1, wherein the second inflatable portion is in fluid communication with the inflator via the first inflatable portion.

11. An inflatable vehicle safety curtain comprising:
a first inflatable portion adapted to be mounted to a vehicle body for fluid communication with an inflator for inflation in response to an impact condition to extend along an interior side of the vehicle body at a first region;
a second inflatable portion mounted to the first portion for fluid communication with the inflator for inflation in response to the impact condition to extend along an interior side of the vehicle body at a second region; and
a chamber valve assembly oriented between the first portion and the second portion for providing fluid communication therebetween, the chamber valve assembly further comprising:
a housing having a first opening towards the first inflatable portion and an opposed second opening towards the second inflatable portion that is greater than the first opening, with a chamber therebetween, and
a valve member oriented in the chamber sized such that fluid flow from the first portion to the second portion actuates the valve member towards the second opening thereby permitting fluid to pass from the first portion to the second portion and fluid flow from the first portion to the second portion actuates the valve member towards the second opening thereby seating the valve for limiting fluid from passing from the second portion to the first portion so that the second portion maintains a level of inflation during impact with an occupant.

12. The inflatable vehicle safety curtain of claim 11 wherein the actuating member is a cylinder.

13. The inflatable vehicle safety curtain of claim 11 wherein the actuating member is a ball.

14. The inflatable vehicle safety curtain of claim 11 further comprising a spring configured to urge the actuating member toward the second opening.

15. An inflatable vehicle safety curtain comprising:
a first inflatable portion adapted to be mounted to a vehicle body for fluid communication with an inflator for inflation in response to an impact condition to extend along an interior side of the vehicle body at a first region;
a second inflatable portion mounted to the first portion for fluid communication with the inflator for inflation in response to the impact condition to extend along an interior side of the vehicle body at a second region; and
a flapper valve oriented between the first portion and the second portion for providing fluid communication therebetween, for permitting fluid to pass from the first portion to the second portion and for limiting fluid from passing from the second portion to the first portion so that the second portion maintains a level of inflation during impact with an occupant.

16. The inflatable vehicle safety curtain of claim 15 wherein the flapper valve is pivotally connected to one of the first portion and the second portion.

17. The inflatable vehicle safety curtain of claim 15 wherein the flapper valve is formed from a plastic.

18. The inflatable vehicle safety curtain of claim 15 wherein the flapper valve is formed from a fabric.

19. The inflatable vehicle safety curtain of claim 15, the flapper valve further includes an elongate conduit adapted to be received within an actuating valve member when the flapper valve is limiting fluid from passing from the second portion to the first portion.

20. The inflatable vehicle safety curtain of claim 15, wherein the flapper valve has a first surface area exposed to the interior of the first inflatable portion and a second surface area exposed to the interior of the second inflatable portion such that the second surface area is greater than the first surface area.
